(19) United States
(12) Patent Application Publication
(10) Pub. No.: US 2026/0036535 A1
(43) Pub. Date: Feb. 5, 2026

(54) SYSTEM AND METHOD FOR SCANNING ELECTRON BEAM IMAGE-FORMATION WITH ELEMENTAL ANALYSIS

(71) Applicant: KLA Corporation, Milpitas, CA (US)

(72) Inventors: Xinrong Jiang, Palo Alto, CA (US); Ralph Nyffenegger, Palo Alto, CA (US); Ye Yang, Fremont, CA (US); Wenjing You, Fremont, CA (US)

(21) Appl. No.: 19/269,695

(22) Filed: Jul. 15, 2025

Related U.S. Application Data
(60) Provisional application No. 63/676,907, filed on Jul. 30, 2024.

(51) Int. Cl. G01N 23/2206; G01N 23/203; G01N 23/2252

(52) U.S. Cl. CPC G01N 23/2206; G01N 23/203; G01N 23/2252; G01N 2223/401

(57) ABSTRACT

A system may include an electron beam source configured to generate a primary electron beam and an electron-optical column including a set of electron-optical elements configured to direct at least a portion of the primary electron beam onto a portion of a sample. The set of electron-optical elements may include an objective lens disposed along an optical axis, where the objective lens includes one or more charge control plates (CCPs), where the electron-optical column includes a detector assembly configured to concurrently collect one or more backscattered electron (BSE) signals and one or more x-ray signals emanated from the sample. The detector assembly may include one or more silicon-drift detector (SDD) sensors and one or more BSE sensors.

### CROSS-REFERENCE TO RELATED APPLICATIONS

The present application claims the benefit under 35 U.S.C § 119(e) to U.S. Provisional Application No. 63/676,907, filed Jul. 30, 2024, which is herein incorporated by reference in the entirety.

### TECHNICAL FIELD

The present disclosure relates generally to sample inspection and, more particularly, to a system and method for scanning electron microscopy (SEM) image-formation with concurrent elemental analysis.

### BACKGROUND

The advancement of three-dimensional (3D) semiconductor devices, such as 3D NAND flash, 3D dynamic random-access memory (DRAM), and 3D logic, has introduced significant challenges for defect inspection and elemental analysis. These devices often contain high-aspect-ratio (HAR) structures, such as memory holes, channel holes, staircase steps, and deep trenches, that extend several microns deep into the sample. Such structures are required to be inspected and reviewed during the fabrication process. Scanning electron microscopy (SEM) techniques are often used to inspect and identify these defects since optical methods are unable to detect defects in deep 3D layers.

SEM systems typically rely on secondary electron (SE) imaging to visualize surface features. However, SE signals are unable to escape from deep within the HAR structures, making them unsuitable for sub-surface defect detection. As such, backscattered electron (BSE) signals, which originate from deeper layers, are used for defect detection. The defects detected using BSE signals are identifiable by means of collecting x-rays for analyzing defect compositions. For example, to identify the elemental composition of detected defects using the BSE signals, energy-dispersive x-ray spectroscopy (EDX) is often used.

However, in existing systems, BSE imaging and x-ray analysis are unable to be performed synchronously due to low signal acquisition. As such, in existing systems, after using BSE to detect defects in SEM images, inspectors have to separately use EDX analysis to identify defect compositions, requiring repeated adjustments and searches (also known as “loop of suffering”).

Further, in conventional EDX systems, silicon lithium detector diodes are used to operate at liquid nitrogen temperature to reduce electron-hole pair, preventing the lithium atoms from diffusing and to reduce the noise in the FET preamplifier. To prevent contamination, build up on the cooling silicon crystal surface, the silicon lithium detector is often isolated from the electron beam column, causing low signal collection of the x-ray signals from the sample.

Therefore, it is desirable to provide systems and methods for curing one or more of the above deficiencies.

### SUMMARY

A system is disclosed, in accordance with one or more embodiments of the present disclosure. In embodiments, the system includes: an electron beam source configured to generate a primary electron beam; an electron-optical column including a set of electron-optical elements configured to direct at least a portion of the primary electron beam onto a portion of a sample. In embodiments, the set of electron-optical elements include: an objective lens disposed along an optical axis, where the objective lens includes one or more charge control plates (CCPs) configured to charge the sample, where the electron-optical column includes a detector assembly configured to concurrently collect one or more backscattered electron (BSE) signals and one or more x-ray signals emanated from the sample as the primary electron beam is scanned across the sample in a scan direction. In embodiments, the detector assembly includes: one or more silicon-drift detector (SDD) sensors, where the one or more SDD sensors include: an anode arranged at a center of the one or more SDD sensors; a plurality of electrode rings surrounding the anode; a cathode; and a silicon single crystal, where the cathode coats a bottom surface of the silicon single crystal and the anode on a top surface of the silicon single crystal. In embodiments, the electron-optical column further includes a secondary electron detector configured to detect secondary electrons emanating from the sample.

A system is disclosed, in accordance with one or more embodiments of the present disclosure. In embodiments, the system includes a scanning electron microscopy (SEM) inspection sub-system. In embodiments, the SEM inspection sub-system includes: an electron beam source configured to generate a primary electron beam; and an electron-optical column including a set of electron-optical elements configured to direct at least a portion of the primary electron beam onto a portion of a sample, where the set of electron-optical elements include: an objective lens disposed along an optical axis, where the objective lens includes one or more charge control plates (CCPs) configured to charge the sample, where the electron-optical column includes a detector assembly configured to concurrently collect one or more backscattered electron (BSE) signals and one or more x-ray signals emanated from the sample as the primary electron beam is scanned across the sample in a scan direction. In embodiments, the detector assembly includes one or more silicon-drift detector (SDD) sensors. In embodiments, the system further includes a controller communicatively coupled to the SEM inspection sub-system, the controller includes one or more processors configured to execute a set of program instructions stored in memory, the set of program instructions configured to cause the one or more processors to: generate one or more BSE images based on the one or more BSE signals collected, where the one or more BSE images include one or more black-and-white images; generate one or more x-ray images based on the one or more x-ray signals collected, where one or more elements in the sample are identified based on the one or more x-ray images; and generate one or more colored images by assigning a color to the one or more elements identified in the sample based on the one or more BSE signals collected.

A method is disclosed, in accordance with one or more embodiments of the present disclosure. In embodiments, the method includes: generating a primary electron beam using an electron beam source; directing the primary electron beam to a sample using a set of electron-optical elements, where the set of electron-optical elements include an objective lens including a charge control plate (CCP); collecting one or more backscattered electron (BSE) signals and one or more x-ray signals emanated from the sample concurrently using a detector assembly, where the detector assembly includes one or more silicon-drift detector (SDD) sensors; generating one or more BSE images based on the one or more BSE signals, where the one or more BSE images include one or more black-and-white images; generating one or more x-ray images based on the one or more x-ray signals collected, where one or more elements in the sample are identified based on the one or more x-ray images; and generate one or more colored images by assigning a color to the one or more elements identified in the sample based on the one or more BSE signals collected.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1 illustrates a simplified block diagram of a system for SEM image-formation with elemental analysis, in accordance with one or more embodiments of the present disclosure.

FIG. 2 illustrates a simplified schematic view of an SEM-based inspection sub-system of the system, in accordance with one or more embodiments of the present disclosure.

FIG. 3A illustrates a top view of a silicon-drift detector (SDD) sensor of the SEM-based sub-system, in accordance with one or more embodiments of the present disclosure.

FIG. 3B illustrates a top view of the SDD sensor of the SEM-based sub-system, in accordance with one or more embodiments of the present disclosure.

FIG. 3C illustrates a cross-section view of the SDD sensor of the SEM-based sub-system, in accordance with one or more embodiments of the present disclosure.

FIG. 4 illustrates a simplified schematic view of the SEM-based sub-system including the SDD sensor, in accordance with one or more embodiments of the present disclosure.

FIG. 5 illustrates a simplified schematic view of the SEM-based sub-system including the SDD sensor and a backscattered electron (BSE) sensor, in accordance with one or more embodiments of the present disclosure.

FIG. 6 illustrates a simplified schematic view of the SEM-based sub-system including a plurality of SDD sensors and a plurality of BSE sensors, in accordance with one or more embodiments of the present disclosure.

FIG. 7 illustrates a simplified top view of the detector assembly including the plurality of SDD sensors and the plurality of BSE sensors, in accordance with one or more embodiments of the present disclosure.

FIG. 8 illustrates a simplified bottom view of the detector assembly including the plurality of SDD sensors and the plurality of BSE sensors, in accordance with one or more embodiments of the present disclosure.

FIG. 9 illustrates a flow diagram illustrating a method for SEM image-formation and elemental analysis, in accordance with one or more embodiments of the present disclosure.

FIG. 10 illustrates a side schematic view of a sample, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a system and method for scanning electron microscopy (SEM) image-formation with concurrent elemental analysis. For example, the system may include a silicon-drift detector (SDD) configured to simultaneously collect backscattered electrons (BSEs) and x-ray signals during SEM inspection (e.g., electron beam inspection (EBI)) to enable real-time, concurrent image formation and elemental analysis. For instance, the SDD may be compact and include a small anode area, such that detector capacitance is reduced and signal voltage is increased. Further, the SDD may be placed within the charge control plate (CCP) region of the SEM column (e.g., at the side of the column or at the center of the column), maximizing the solid angle for x-ray collection. In this regard, the signal-to-noise ratio may be improved and x-ray collection efficiency may be enhanced.

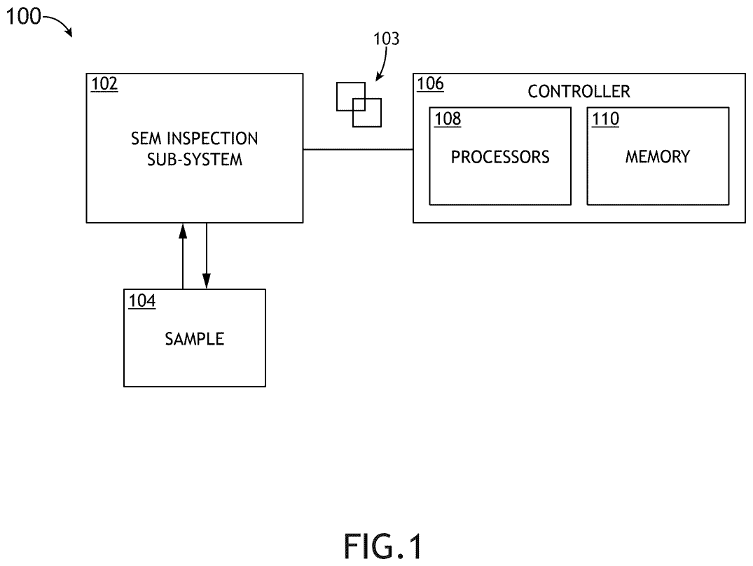

Referring now to FIGS. 1-10, systems and methods for SEM image-formation with elemental analysis are described in greater detail in accordance with one or more embodiments of the present disclosure.

FIG. 1 illustrates a simplified block diagram view of a system 100 for SEM image-formation with elemental analysis, in accordance with one or more embodiments of the present disclosure.

In embodiments, the system 100 includes an SEM inspection sub-system 102 configured to perform SEM image-formation concurrently with real-time (or near real-time) elemental analysis based on one or more backscattered electron (BSE) signals and one or more x-ray signals emanating from a sample 104. For example, as will be discussed further herein, the SEM inspection sub-system 102 may include a detector assembly configured to synchronously collect the BSE signals and x-ray signals emanated from the sample 104.

As previously discussed herein, in existing systems BSE imaging and x-ray analysis are unable to be performed synchronously due to low signal acquisition. As such, energy-dispersive x-ray spectroscopy (EDX) is required to be preformed separately to identify defect compositions. However, such process is tedious and time consuming since repeated adjustments and searches is needed (also known as “loop of suffering”). It is contemplated herein that since the detector assembly of the SEM inspection sub-system 102 is configured to concurrently detect BSE signals and x-ray signals emanating from the sample, the system 100 is able to perform SEM image-formation concurrently with elemental analysis.

The system 100 further includes a controller 106 communicatively coupled to the SEM inspection sub-system 102. The controller 106 may include one or more processors 108 and memory 110. The one or more processors 108 may be configured to execute a set of program instructions maintained in the memory 110, where the set of program instructions may be configured to cause the one or more processors 108 to perform one or more functions (or steps).

For example, the one or more processors 108 may be configured to receive one or more x-ray signals and one or more BSE signals detected by the detector assembly. By way of another example, the one or more processors 108 may be configured to generate one or more images 103 based on the concurrently detected BSE and x-ray signals. For instance, the one or more processors 108 may be configured to generate an elemental spectrum with live (real-time or near real-time) elemental analysis. In this regard, the collected x-ray signals may be processed using software algorithms stored in memory on the controller 106 to automatically identify present elements. As such, the x-ray signal may show a spectrum that displays the peaks correlated to the elemental composition of the defects. By way of another example, the one or more processors 108 may be configured to generate an elemental mapping of the defects. In this regard, the elements may be subsequently assigned colors layered with the signal from the BSE detector to deliver a colored image.

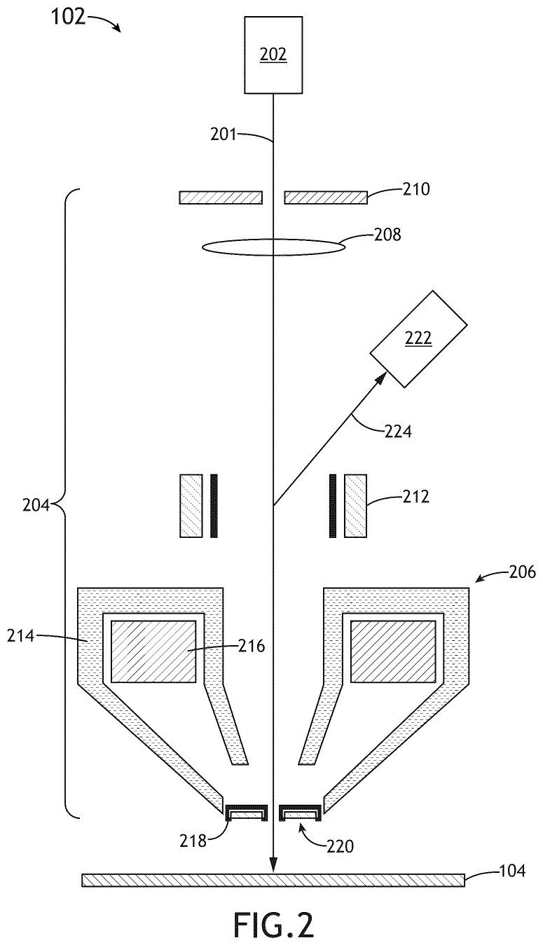

FIG. 2 illustrates a simplified schematic view of the SEM inspection sub-system 102, in accordance with one or more embodiments of the present disclosure.

In embodiments, the SEM inspection sub-system 102 includes one or more electron beam sources 202 configured to direct one or more primary electron beams 201 to the sample 104.

The one or more electron beam sources 202 may include any type of electron emitter suitable for electron emission. For example, the one or more electron bean sources 202 may include one or more field emission guns (FEGs). The particle emission from the FEG may include any type of particle emission such as, but not limited to, thermal field emission (TFE). In a non-limiting example, the one or more FEGs may include one or more TFE guns with high brightness to provide high resolution with a large depth of focus (DOF).

The SEM inspection sub-system 102 includes an electron-optical column 204 including a set of electron-optical elements configured to direct at least a portion of the primary electron beam 201 onto a portion of the sample 104.

The set of electron-optical elements may include, but are not limited to, an objective lens 206 disposed along an optical axis, a condenser lens 208, an aperture 210, one or more deflectors 212 (e.g., one or more Wien filters), and the like. The condenser lens 208 may be positioned between the electron beam source 202 and the objective lens 208, where the condenser lens 208 may be configured to adjust one or more image-forming conditions of the SEM inspection sub-system 102. The aperture 210 may be arranged between the electron beam source 202 and the objective lens 206, where the aperture 210 may be configured to adjust a beam current of the one or more electron beam sources 202.

The objective lens 206 may include a magnetic objective lens including a pole piece 214 and one or more coils 216. The magnetic objective lens 206 may further include one or more charge control plates (CCPs) 218. For example, the one or more CCPs 218 may be used to charge the sample 104 for a specific, extracting field, and thereby control the depth of the field of view (FOV) to be imaged.

In embodiments, the SEM inspection sub-system 102 includes a detector assembly 220 integrated into the one or more CCPs 218. For example, the detector assembly 220 may be configured to concurrently collect one or more backscattered electron (BSE) signals 203 and one or more x-ray signals 205 as the primary electron beam 201 from the electron source 202 scans across the sample 104.

It is contemplated herein that to generate high yields of BSE signals and x-ray signals in deep layers of the sample 104, a high beam current (BC) and high landing energy (V_{LE}) is needed for the primary electron beam 201. Further, in order to obtain a large DOF to meet HAR requirements, the primary beam 201 should have a small numeral aperture (NA) (e.g., small beam angle β). Under such conditions, the spherical aberration blur dₛ and chromatic aberration blur d_{c} may be negligible (as shown and described Equations 1.1-1.2, respectively, below), compared to the source image d_{g} and diffraction blur d_{λ} (as shown and described by equations 1.3-1.4 below).

$${d}_{s} = 0.18 {C}_{s} {β}^{3} \qquad Eqn . 1.1$$

$${d}_{c} = 0.34 {C}_{c} \frac{Δ E}{{V}_{L E}} β \qquad Eqn . 1.2$$

$${d}_{g} = 0.707 {( \frac{B C}{{π}^{2} {β}^{2} {V}_{LE} {B}_{r} / 4} )}^{1 / 2} \qquad Eqn . 1.3$$

$${d}_{λ} = 0.54 \frac{λ}{β} , where λ = \frac{h}{\sqrt{2 {meV}_{L E}}} \qquad Eqn . 1.4$$

where BC is the primary beam current, V_{LE} is the primary beam landing energy voltage, β is the beam half angle (e.g., the NA-optical numeric aperture), Cₛ and C_{c} are the spherical aberration coefficient and chromatic aberration coefficient, respectively, ΔE is the source energy spread, λ is the electron wavelength, m is the electron mass, e is the electron charge, h is the Planck constant, and Bᵣ is reduced source brightness (which is given by Eqn. 2 shown and described below).

$${B}_{r} = \frac{4 {J}_{α}}{π {d}_{v}^{2} {V}_{e x t}} \qquad Eqn . 2$$

where J_{α} is the virtual source angular intensity under extractor voltage Vₑₓₜ, and dᵥ is the virtual source size.

As such, the resolution may be dominated by the source image (d_{g}), such that all other blurs (e.g., dₛ, d_{c}, and d_{λ}) are negligible, such that the primary beam 201 may have a small numerical aperture (NA) to scan across the sample 104 with a high aspect ratio (HAR) up to at least approximately 1:100.

In embodiments, the detector assembly 220 includes one or more silicon-drift detector (SDD) sensors. For example, the one or more SDD sensors may be integrated into the one or more CCPs 218. In this regard, the CCP plane may be used as the detection plane because the working distance (WD) between the CCP and the sample plane may be relatively small in the SEM inspection sub-system 102 (e.g., between 1-2 mm approximately). As such, the one or more SDD sensors may improve x-ray collection efficiency, such that image-formation and elemental analysis may be concurrently performed.

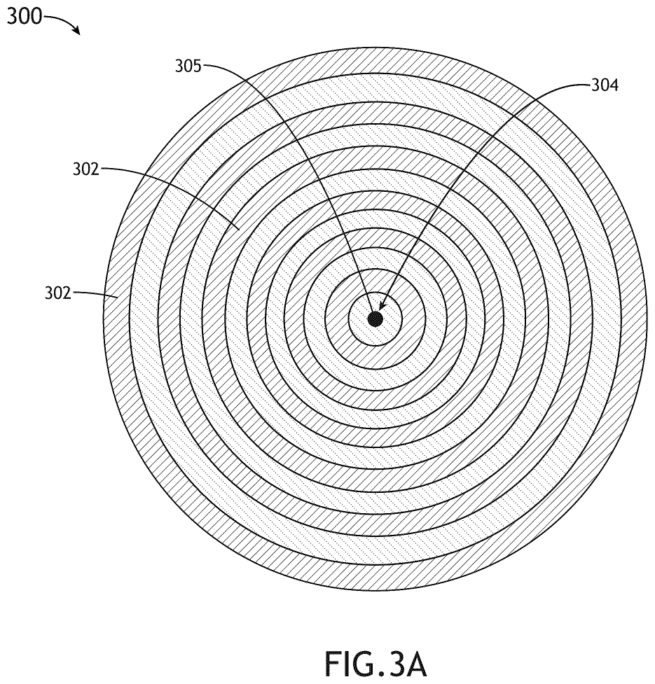

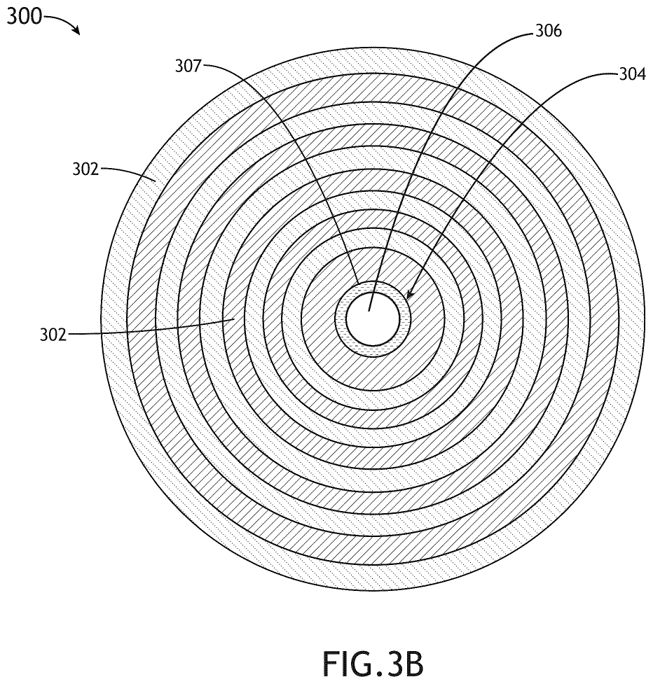

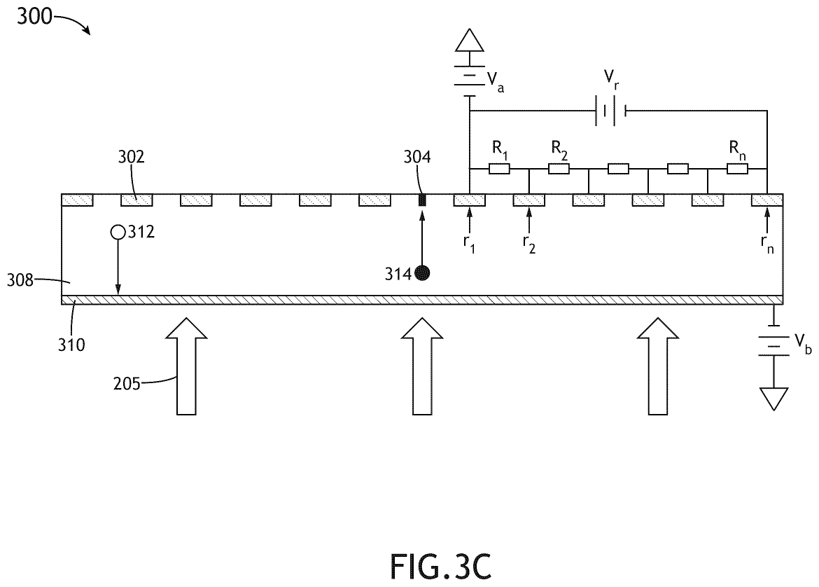

FIG. 3A and FIG. 3B illustrate top schematic views of an SDD sensor 300, in accordance with one or more embodiments of the present disclosure. FIG. 3C illustrates a cross-sectional view of the SDD sensor 300 depicted in FIG. 3A, in accordance with one or more embodiments of the present disclosure.

In embodiments, each SDD sensor 300 includes a plurality of electrode rings 302 and an anode 304. For example, the anode 304 may be arranged at the center of the SDD sensor 300, where the plurality of electrode rings 302 surround the anode 304.

Referring to FIG. 3A, the anode 304 may include a hollow anode 305 arranged at the center of the SDD sensor 300. Referring to FIG. 3B, the anode 304 may include a line anode 307 (or annular anode 307) arranged at the center of the SDD sensor 300. For example, the SDD sensor 300 may include a hole 306 at the center of the SDD sensor 300, where the hole 306 is defined by an inner circumference of the line anode 307. For instance, the hole 306 may allow the primary electron beam 201 to pass through the SDD sensor 300. In a non-limiting example, the annular line anode 307 may have a width of approximately 50 nm. In this regard, for an anode ring with a diameter of 1 mm, the anode area may be approximately 157 square microns.

Each SDD sensor 300 may include a silicon single crystal 308 and a cathode 310. For example, the cathode 310 may coat a bottom surface of the silicon crystal 308. The anode 304 may be arranged near a top surface of the silicon single crystal 308 at (or around) the center of the SDD sensor 300. A negative potential (V_{b}) may be applied to the cathode 310 and a positive potential (Vₐ) may be applied to the anode 304. For example, the negative potentials (V_{b}) may increase stepwise from the outside to the inside of the SDD sensor 300 (e.g., from the outer electrode ring to the inner electrode ring) when applied to the plurality of electrode rings 302 (e.g., r₁, r₂, . . . , rₙ) by distributing the voltage Vᵣ with the resistances R₁, R₂, . . . , Rₙ.

It is contemplated herein that when the characteristic x-ray signals 205 are incident on the silicon crystal 308 through the cathode 310, electron-hole pairs may be generated in proportion to the x-ray energy. The holes 312 in those electron-hole pairs may move toward the cathode 310, such that the electrons 314 move to both the anode 304 and the plurality of electrode rings 302. In this regard, the electrons that reach the plurality of electrode rings 302 may be finally collected by the anode 304 via the stepwise potentials (V_{b}).

Further, it is contemplated herein that the signal-to-noise ratio of the one or more SDD sensors 300 may be significantly improved due to a large reduction of capacitance C. For example, with the same size of detectors, the capacitance of the SDD sensor of the present disclosure may be less than 5% of the capacitance of a conventional EDX sensor, thereby improving the signal-to-noise ratio greater than 20×.

In a non-limiting example, the SDD sensors 300 may be arranged at one or more sides of the electron-optical column 204. For example, where the SDD sensors 300 are arranged at one or more sides of the electron-optical column 204, the anode 304 may include the hollow anode 305 as shown in FIG. 3A. In an additional non-limiting example, the SDD sensors 300 may be arranged at the center of the electron-optical column 204. For example, where the SDD sensors 300 are arranged at the center of the electron-optical column 204, the anode 304 may include the line anode 307 as shown in FIG. 3B.

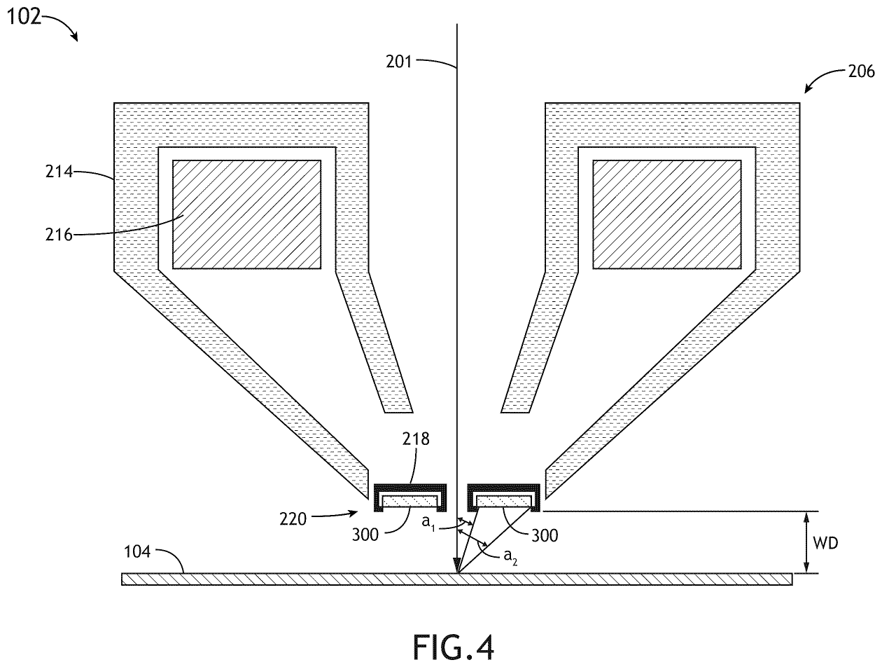

FIG. 4 illustrates a schematic view of the detector assembly 220 including two SDD sensors 300, in accordance with one or more embodiments of the present disclosure.

In embodiments, the detector assembly 220 includes two SDD sensors 300 integrated into two CCPs 218. For example, the two SDD sensors 300 integrated into the two CCPs 218 may be arranged near the bottom of the pole piece 214 of the magnetic objective lens 206, where the SDD sensors 300 integrated with the CCPs 218 are a working distance (WD) from a top surface of the sample 104. Further, a first end of the SDD sensor 300 may be arranged at a first angle α₁ with respect to the primary beam 201 and a second end of the SDD sensor 300 may be arranged at a second angle α₂ with respect to the primary beam 201. In this regard, each SDD sensor 300 may be configured to collect the x-ray signals 205 generated from the sample 104 as the primary beam 201 scans the sample 104. As previously mentioned herein, since the SDD sensor 300 are arranged at the CCP plane, the detection plane may be a working distance (WD) from the sample 104, thereby increasing x-ray collection efficiency.

In a non-limiting example, the SDD sensor 300 may include the SDD sensor 300 shown in FIG. 3B, where the anode 304 includes the line anode 307. Continuing with the above example, the x-ray signals 205 may be collected by the SDD sensor 300 in the range from α₁ to α₂ via the central hole 306 and the plurality of electrode rings 302 (or detector rims).

The x-ray collection efficient (γ) may be shown and described below:

$$γ = \frac{1}{2} ( 1 - cos α ) \qquad Eqn . 3$$

where γ is the CCP x-ray collection efficiency and α is a half solid angle of the x-rays collection the SDD sensors 300. In a non-limiting example, the working distance (WD) may be between approximately 1 mm and 2 mm, such the x-ray CE (γ) may be 0.34 (or 34%) when α₁=20° and α₂=75° according to Eqn. 3. In this regard, a 45× higher x-ray CE is produced, compared to the conventional EDX systems as previously discussed.

As such, the total signal-to-noise ratio in the SEM inspection sub-system 102 including the SDD sensor 300 may be improved by approximately 3 orders of magnitude (e.g., 1000×), where >20× is due to a reduction of detector capacitance and >45× is due to an increase of x-ray CE (γ). It is contemplated herein that this reduces the x-ray signal acquisition time significantly and makes it possible to form the secondary electron (SE) image and x-ray image synchronously for live elemental analysis, as discussed further herein.

In embodiments, the detector assembly 220 includes one or more backscattered electron (BSE) sensors. For example, the one or more BSE sensors may be integrated into the one or more CCPs 218. In this regard, the one or more BSE sensors may improve the BSE collection efficiency, as previously discussed herein.

In a non-limiting example, the one or more BSE sensors may include a scintillation detector. For instance, the one or more BSE sensors may be formed of a scintillation material for detecting BSE signals along with a light-guide and photomultiplier tube (PMT) for amplifying the BSE signals. In an additional non-limiting example, the one or more BSE sensors may include an avalanche photodiode (APD) detector. It is contemplated herein that where the detector assembly 220 includes SDD sensors and BSE sensors, there doesn't exist cross-talks, because the scintillator of the BSE sensor is insensitive to x-ray signals. Further, the SDD sensor is insensitive to BSE signals.

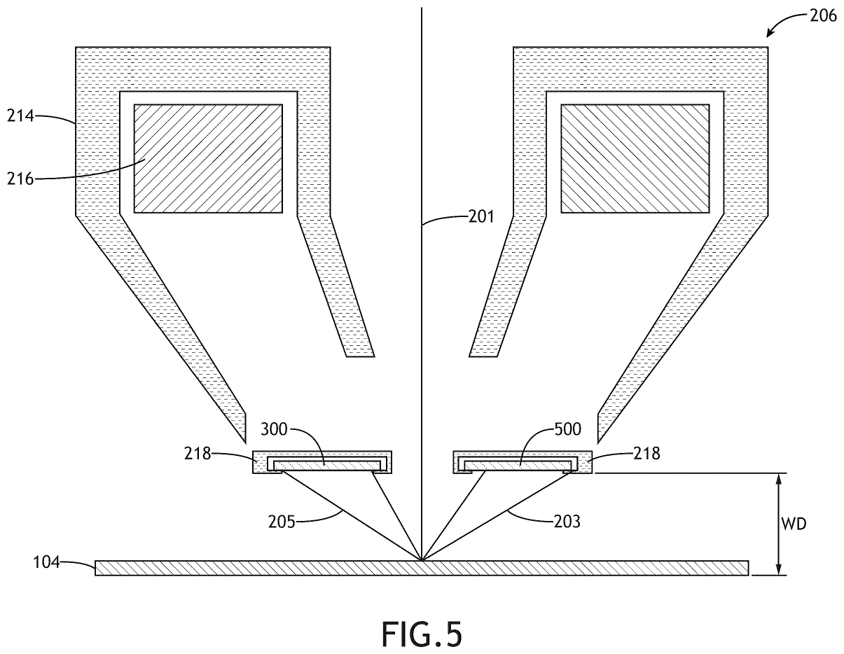

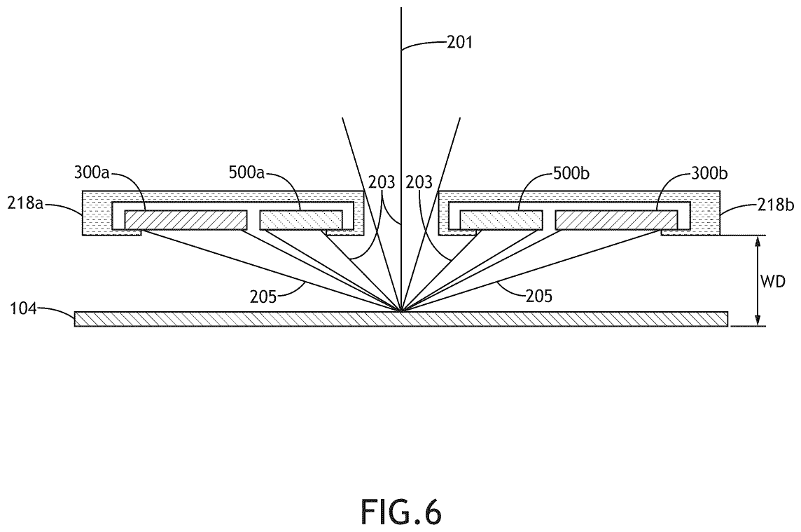

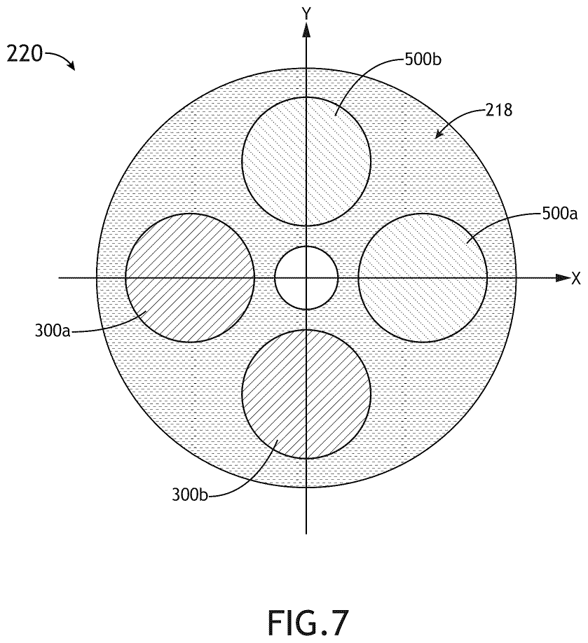

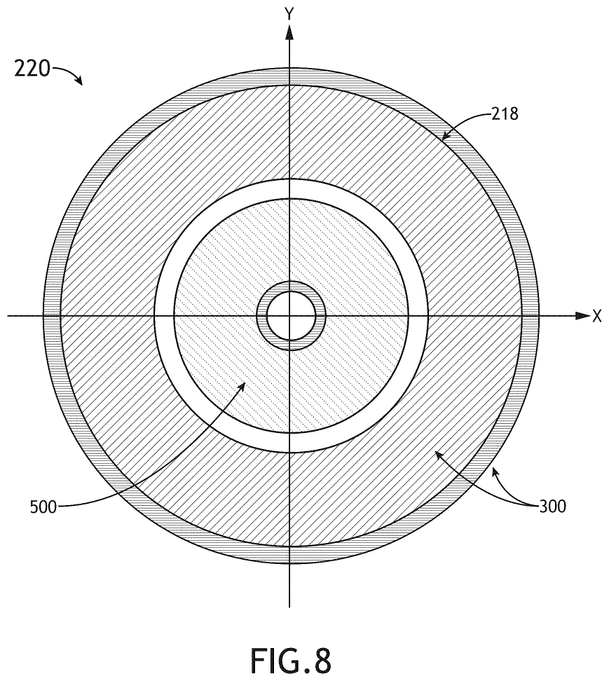

FIG. 5 and FIG. 6 illustrate schematic views of the detector assembly 220 including one or more SDD sensors 300 and one or more BSE sensors 500, in accordance with one or more embodiments of the present disclosure. FIG. 7 illustrates a top view of the detector assembly 220 shown in FIG. 6, in accordance with one or more embodiments of the present disclosure. FIG. 8 illustrates a bottom view of the detector assembly shown in FIG. 6, in accordance with one or more embodiments of the present disclosure.

In embodiments, the detector assembly 220 includes one or more SDD sensors 300 configured to collect the x-ray signals 205 emanated from the sample 104 and one or more BSE sensors 500 configured to collect the one or more BSE signals 203 emanated from the sample 104.

Referring to FIG. 5, in a non-limiting example, the electron-optical column 204 may include two CCPs 218, where a first CCP is integrated with the SDD sensor 300 and a second CCP is integrated with the BSE sensor 500, such that the detector assembly 220 is configured to simultaneously collect the x-ray signals and the BSE signals emanated from the sample 104.

Referring to FIGS. 6-8, in a non-limiting example, the electron-optical column 204 may include two CCPs 218, where a first CCP 218a is integrated with a first SDD sensor 300a and a first BSE sensor 500a and a second CCP 218b is integrated with a second SDD sensor 300b and a second BSE sensor 500b, such that the detector assembly 220 is configured to simultaneously collect a plurality of x-ray signals and a plurality of BSE signals emanated from the sample 104. For instance, the first SDD sensor 300a may be configured to collect a first set of x-ray signals 205 and the second SDD sensor 300b may be configured to collect a second set of x-ray signals 205. Further, the first BSE sensor 500a may be configured to collect a first set of BSE signals 203 and the second BSE sensor 500b may be configured to collect a second set of BSE signals 203.

It is contemplated herein that the size of the BSE sensors 500a, 500b may be different than the size of the SDD sensors 300a, 300b, as such FIGS. 6-7 are provided merely for illustrative purposes and shall not be construed as limiting the scope of the present disclosure. Further, it is contemplated herein that the size of the BSE sensors 500a, 500b and/or the SDD sensors 300a, 300b may be adjusted based on the yields of BSE and x-ray signals and/or configuration of the detector assembly 220 (and/or electron-optical column 204).

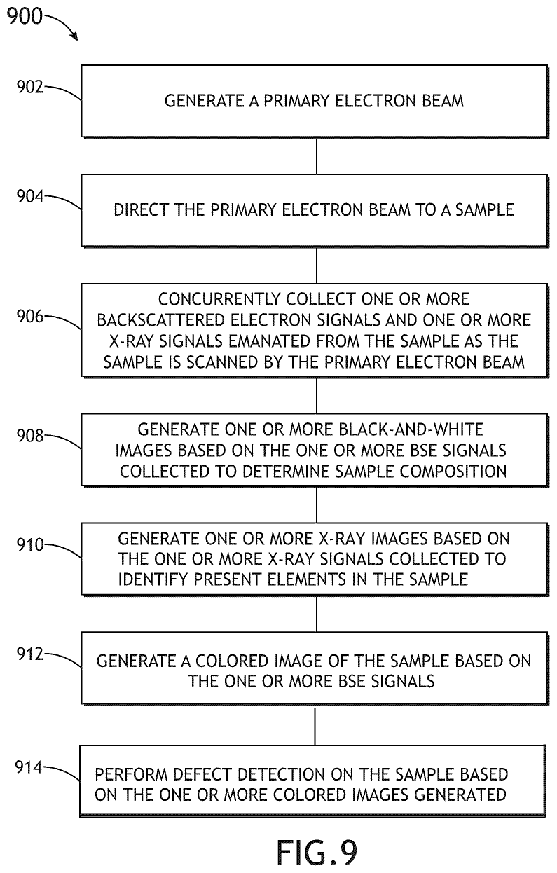

FIG. 9 illustrates a flow diagram depicting a method 900 of SEM image-formation and concurrent live-elemental analysis, in accordance with one or more embodiments of the present disclosure. It is noted herein that the embodiments and enabling technologies described previously herein in the context of the system 100 should be interpreted to extend to the method 900. It is further noted, however, that the method 900 is not limited to the architecture of the system 100.

In embodiments, the method 900 includes a step 902 of generating a primary electron beam. For example, the one or more electron beam sources 202 may generate the primary beam 201.

In embodiments, the method 900 includes a step 904 of directing the primary electron beam to the sample. For example, the set of electron optical elements of the electron-optical column 204 may be configured to direct the primary beam 201 to the sample 104 as the sample 104 is scanned by the primary beam 201. For instance, the objective lens 206 may direct the primary beam 201 to the sample 104 as the sample 104 is scanned by the primary beam 201.

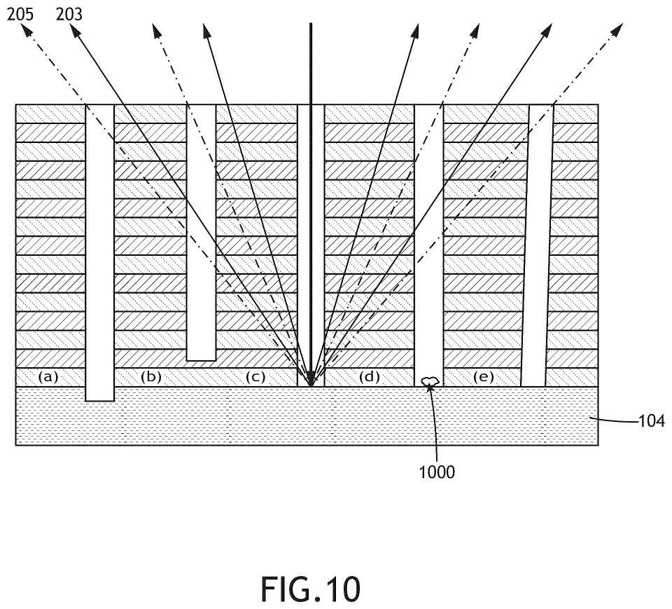

In embodiments, the method 900 includes a step of 906 of concurrently collecting one or more BSE signals and one or more x-ray signals emanated from the sample. As shown in FIG. 10, three signals may be generated from a bottom surface of the sample 104 when the primary beam 201 is directed to a portion of the sample 104. These three signals may include secondary electron (SE) signals, backscattered electron (BSE) signals, and x-ray signals. As shown in FIG. 10, the SE signal is not able to escape from the holes because the SEs are clipped by the walls of the holes. As such, only the BSE and x-ray signals may be detected because the high-energy BSEs and x-rays are able to penetrate through thin film layers of the sample 104.

The detector assembly 220 may concurrently collect the BSE signals and x-ray signals as they are emanated from the sample 104. For example, the SDD sensors 300 may collect the one or more x-ray signals 205 and the BSE sensors 500 may collect the one or more BSE signals 203.

In embodiments, the method 900 includes a step 908 of generating one or more BSE images based on the one or more BSE signals. For example, the one or more processors 108 may be configured to generate the one or more BSE images based on the one or more BSE signals 203, where the BSE image may include a black-and-white image containing information regarding sample composition (e.g., where heavier phases appear brighter). In this regard, sample topographical information may be obtained using the one or more BSE images.

In embodiments, the method 900 includes a step 910 of generating one or more x-ray images based on the one or more x-ray signals to identify one or more elements present in the sample. For example, the one or more processors 108 may be configured to identify one or more elements present in the sample 104 by analyzing the one or more x-ray signals collected by the SDD sensors 300. For instance, the SDD sensor 300 may generate an x-ray image based on the x-ray signals, where the x-ray image may be used to measure characteristic x-ray emissions produced during sample irradiation by the primary beam 201. In this regard, the collected x-ray signals may be processed, via the one or more processors 108, using one or more software algorithms stored in memory 110 on the controller 106, where the one or more software algorithms may automatically identify present elements.

In embodiments, the method 900 includes a step 912 of generating one or more colored images of the sample based on the one or more BSE signals collected (in step 906). For example, the identified elements may be assigned colors and layered with the signal from the BSE sensor to generate the colored image. As such, by comparing the combined BSE/SEM imaging system of the present disclosure to a SE or BSE imaging system, the system of the present disclosure provides more information regarding sample composition and elemental distribution within the same acquisition time and using the same operation conditions, implementing live elemental analysis.

In embodiments, the method 900 includes a step 914 of performing defect detection based on the colored image generated (in step 914). For example, a defect 1000 may be identified on the sample 104 based on the colored image generated (in step 914), where the sample composition and elemental distribution from the colored image may be used to identify the respective defect 1000.

Referring again to FIGS. 1-2, additional components of the system 100 are described in greater detail in accordance with one or more embodiments of the present disclosure.

The SEM inspection sub-system 102 may include a secondary electron detector 222 configured to collect secondary 224 and/or BSE signals 203 emanated from the surface of the sample 104 in response to the one or more electron beams 201.

It is noted that the electron optical assembly of the SEM inspection sub-system 102 is not limited to the electron-optical elements depicted in FIG. 2, which is provided merely for illustrative purposes. It is further noted that the system 100 may include any number and type of electron-optical elements necessary to direct/focus the one or more electron beams 201 onto the sample 104 and, in response, collect and image the emanated secondary electrons, x-ray signals, and/or backscattered electrons onto the secondary electron detector 222.

For example, the one or more deflectors 212 may include one or more Wien filters configured to direct the one or more secondary electrons to the secondary electron detector 222.

SEM sub-systems are generally discussed in U.S. Pat. No. 11,239,048, issued Feb. 1, 2022; U.S. Pat. No. 11,410,830, issued Aug. 9, 2022; U.S. Patent Publication No. 2024/0194440, published Jun. 13, 2024; U.S. Patent Publication No. 2022/0108862, published Apr. 7, 2022; and U.S. Pat. No. 11,880,193, issued Jan. 23, 2024, all of which are incorporated by reference in their entirety.

The sample 104 may include any sample known in the art including, but not limited to, a wafer, a reticle, a photomask, flat panel display, and the like. In embodiments, the sample 104 is disposed on a stage assembly to facilitate movement of the sample 104. For example, the stage assembly may include an actuatable stage. For instance, the stage assembly may include, but is not limited to, one or more translational stages suitable for selectively translating the sample 104 along one or more linear directions (e.g., x-direction, y-direction and/or z-direction). By way of another example, the stage assembly may include, but is not limited to, one or more rotational stages suitable for selectively rotating the sample 104 along a rotational direction. By way of another example, the stage assembly may include, but is not limited to, a rotational stage and a translational stage suitable for selectively translating the sample 104 along a linear direction and/or rotating the sample 104 along a rotational direction. It is noted herein that the system 100 may operate in any scanning mode known in the art.

The one or more processors 108 of the controller 106 may generally include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 108 may include any device configured to execute algorithms and/or instructions (e.g., program instructions stored in memory). In one embodiment, the one or more processors 108 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of the system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 106 may include one or more controllers housed in a common housing or within multiple housings. In this way, any controller or combination of controllers may be separately packaged as a module suitable for integration into metrology system 100. Further, the controller 106 may analyze or otherwise process data received from the SEM inspection sub-system 102 and feed the data to additional components within the system 100 or external to the system 100.

Further, the memory 110 may include any storage medium known in the art suitable for storing program instructions executable by the associated one or more processors 108. For example, the memory 110 may include a non-transitory memory medium. As an additional example, the memory 110 may include, but is not limited to, a read-only memory, a random-access memory, a magnetic or optical memory device (e.g., disk), a magnetic tape, a solid-state drive and the like. It is further noted that memory 110 may be housed in a common controller housing with the one or more processors 108.

In this regard, the controller 106 may execute any of various processing steps associated with inspection. For example, the controller 106 may be configured to generate control signals to direct or otherwise control the inspection sub-system 102, or any components thereof. For instance, the controller 106 may be configured to direct the stage to translate the sample 104 along one or more measurement paths or swaths. By way of another example, the controller 106 may be configured to receive images from the SEM inspection sub-system 102. By way of another example, the controller 106 may generate correctables for one or more additional fabrication sub-systems as feedback and/or feed-forward control of the one or more additional fabrication sub-systems based on measurements from the SEM inspection sub-system 102.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be implemented (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system, the system comprising:
an electron beam source configured to generate a primary electron beam;
an electron-optical column including a set of electron-optical elements configured to direct at least a portion of the primary electron beam onto a portion of a sample,
wherein the set of electron-optical elements comprise:
an objective lens disposed along an optical axis, wherein the objective lens includes one or more charge control plates (CCPs) configured to charge the sample,
wherein the electron-optical column includes a detector assembly configured to concurrently collect one or more backscattered electron (BSE) signals and one or more x-ray signals emanated from the sample as the primary electron beam is scanned across the sample in a scan direction, wherein the detector assembly comprises:
one or more silicon-drift detector (SDD) sensors, wherein the one or more SDD sensors comprise:
an anode arranged at a center of the one or more SDD sensors;
a plurality of electrode rings surrounding the anode;
a cathode; and
a silicon single crystal, wherein the cathode coats a bottom surface of the silicon single crystal and the anode is arranged on a top surface of the silicon single crystal; and
a secondary electron detector configured to detect secondary electrons emanating from the sample.

2. The system of claim 1, wherein the anode of the one or more SDD sensors comprises a hollow anode arranged at the center of the one or more SDD sensors.

3. The system of claim 1, wherein the anode of the one or more SDD sensors comprises an annular linear anode defining a hole at the center of the one or more SDD sensors, wherein the primary electron beam penetrates through the hole defined by the annular linear anode at the center of the one or more SDD sensors.

4. The system of claim 2, wherein the detector assembly is arranged at a side of the electron-optical column.

5. The system of claim 3, wherein the detector assembly is arranged at a center of the electron-optical column.

6. The system of claim 1, wherein a negative potential is applied to the cathode and a positive potential is applied to the anode, wherein the negative potential increases stepwise from an outer electrode ring of the plurality of electrode rings to an inner electrode ring of the plurality of electrode rings.

7. The system of claim 1, wherein the detector assembly further comprises:
one or more BSE sensors, wherein the one or more SDD sensors are configured to collect the one or more x-ray signals and the one or more BSE sensors are configured to collect the one or more BSE signals.

8. The system of claim 7, wherein the detector assembly comprises:
a first SDD sensor integrated with a first CCP;
a second SDD sensor integrated with a second CCP;
a first BSE sensor integrated with the first CCP; and
a second BSE sensor integrated with the second CCP.

9. The system of claim 7, wherein the one or more BSE sensors include one or more avalanche photodiode detectors.

10. The system of claim 7, wherein the one or more BSE sensors include one or more photomultiplier tube detectors.

11. The system of claim 1, wherein the objective lens comprises a magnetic objective lens including one or more pole pieces and one or more coils.

12. The system of claim 1, wherein the electron beam source includes a thermal field emission gun.

13. The system of claim 1, wherein the set of electron-optical elements include a condenser lens positioned between the electron beam source and the objective lens.

14. The system of claim 1, wherein the set of electron-optical elements include one or more apertures positioned between the electron beam source and the objective lens.

15. The system of claim 1, wherein the set of electron-optical elements include one or more Wien filters.

16. A system comprising:
a scanning electron microscopy (SEM) inspection sub-system, wherein the SEM inspection sub-system comprises:
an electron beam source configured to generate a primary electron beam; and
an electron-optical column including a set of electron-optical elements configured to direct at least a portion of the primary electron beam onto a portion of a sample,
wherein the set of electron-optical elements comprise:
an objective lens disposed along an optical axis, wherein the objective lens includes one or more charge control plates (CCPs) configured to charge the sample,
wherein the electron-optical column includes a detector assembly configured to concurrently collect one or more backscattered electron (BSE) signals and one or more x-ray signals emanated from the sample as the primary electron beam is scanned across the sample in a scan direction, wherein the detector assembly comprises one or more silicon-drift detector (SDD) sensors; and
a controller communicatively coupled to the SEM inspection sub-system, the controller includes one or more processors configured to execute a set of program instructions stored in memory, the set of program instructions configured to cause the one or more processors to:
generate one or more BSE images based on the one or more BSE signals collected, wherein the one or more BSE images include one or more black-and-white images;
generate one or more x-ray images based on the one or more x-ray signals collected, wherein one or more elements in the sample are identified based on the one or more x-ray images; and
generate one or more colored images by assigning a color to the one or more elements identified in the sample based on the one or more BSE signals collected.

17. The system of claim 16, wherein the one or more SDD sensors comprise:
an anode arranged at a center of the one or more SDD sensors;
a plurality of electrode rings surrounding the anode;
a cathode; and
a silicon single crystal, wherein the cathode coats a bottom surface of the silicon single crystal and the anode is arranged on a top surface of the silicon single crystal.

18. The system of claim 17, wherein the anode of the one or more SDD sensors comprises a hollow anode arranged at the center of the one or more SDD sensors.

19. The system of claim 17, wherein the anode of the one or more SDD sensors comprises an annular linear anode defining a hole at the center of the one or more SDD sensors, wherein the primary electron beam penetrates through the hole defined by the annular linear anode at the center of the one or more SDD sensors.

20. The system of claim 18, wherein the detector assembly is arranged at a side of the electron-optical column.

21. The system of claim 19, wherein the detector assembly is arranged at a center of the electron-optical column.

22. The system of claim 17, wherein a negative potential is applied to the cathode and a positive potential is applied to the anode, wherein the negative potential increases stepwise from an outer electrode ring of the plurality of electrode rings to an inner electrode ring of the plurality of electrode rings.

23. The system of claim 16, wherein the detector assembly further comprises:
one or more BSE sensors, wherein the one or more SDD sensors are configured to collect the one or more x-ray signals and the one or more BSE sensors are configured to collect the one or more BSE signals.

24. The system of claim 23, wherein the detector assembly comprises:
a first SDD sensor integrated with a first CCP;
a second SDD sensor integrated with a second CCP;
a first BSE sensor integrated with the first CCP; and
a second BSE sensor integrated with the second CCP.

25. The system of claim 23, wherein the one or more BSE sensors include one or more avalanche photodiode detectors.

26. The system of claim 23, wherein the one or more BSE sensors include one or more photomultiplier tube detectors.

27. The system of claim 16, wherein the objective lens comprises a magnetic objective lens including one or more pole pieces and one or more coils.

28. The system of claim 16, wherein the electron beam source includes a thermal field emission gun.

29. The system of claim 16, wherein the set of electron-optical elements include a condenser lens positioned between the electron beam source and the objective lens.

30. The system of claim 16, wherein the set of electron-optical elements include one or more apertures positioned between the electron beam source and the objective lens.

31. The system of claim 16, wherein the set of electron-optical elements include one or more Wien filters.

32. A method comprising:
generating a primary electron beam using an electron beam source;
directing the primary electron beam to a sample using a set of electron-optical elements, wherein the set of electron-optical elements include an objective lens including a charge control plate (CCP);
collecting one or more backscattered electron (BSE) signals and one or more x-ray signals emanated from the sample concurrently using a detector assembly, wherein the detector assembly comprises one or more silicon-drift detector (SDD) sensors;
generating one or more BSE images based on the one or more BSE signals, wherein the one or more BSE images include one or more black-and-white images;
generating one or more x-ray images based on the one or more x-ray signals collected, wherein one or more elements in the sample are identified based on the one or more x-ray images; and
generate one or more colored images by assigning a color to the one or more elements identified in the sample based on the one or more BSE signals collected.

33. The method of claim 32, further comprising:
identifying one or more defects on the sample based on the one or more colored images generated.
